(19) United States
(12) Patent Application Publication
(10) Pub. No.: US 2021/0171789 A1
(43) Pub. Date: Jun. 10, 2021

(54) Fine Grain Filler with Improved Wettability

(71) Applicant: Ankerpoort N.V., Maastricht (NL)

(72) Inventor: Charles Edwards, Spruce Pine, NC (US)

(73) Assignee: Ankerpoort N.V.

(21) Appl. No.: 17/113,487

(22) Filed: Dec. 7, 2020

Related U.S. Application Data
(60) Provisional application No. 62/945,183, filed on Dec. 8, 2019.
(60) Provisional application No. 63/034,582, filed on Jun. 4, 2020.

(51) Int. Cl. C09D 7/62; C09C 1/40; C09C 3/00; C09C 3/04; C09C 3/08; C09D 15/00; C09D 5/03; C09D 11/037; C09D 7/40

(52) U.S. Cl. CPC C09D 7/62; C09C 1/40; C09C 3/006; C09C 3/041; C01P 2004/61; C09D 15/00; C09D 5/035; C09D 11/037; C09D 7/69; C09C 3/08

(57) ABSTRACT

A filler for a coating including a powder formed from igneous rock with substantially no free silica and a Mohs hardness of at least 5 and a controlled maximum particle size of less than 6 microns, wherein said particles have a surface fluid layer of a lubricative fluid to drastically increase the wettability of said powder and a method of producing the same.

This application claims priority in U.S. Provisional Application Ser. No. 62/945,183 that was filed on Dec. 8, 2019 and on U.S. Provisional Application Ser. No. 63/034,582 that was filed on Jun. 4, 2020, which are both incorporated by reference herein.

The present invention relates to mineral fillers of the type used in coatings, such as paint, and more particularly to a fine grain filler with improved wettability.

### BACKGROUND

In industries, like production of paint and wood coverings, there is a desire to improve the substance in a manner to increase wear or hardness and other physical properties by adding selected fillers with desired properties. One of the most advantageous fillers is a mass of small particle igneous rock having a Mohs hardness of over 5.0 (in practice about 6 to 7) and of the type having substantially no free silica so it is not considered environmentally hazardous. To meet these standards, a feldspar rock like nepheline syenite is preferred, but other similar hard igneous rocks are also used. However, such fillers are more advantages if they have extremely small maximum particle size, technically referred to as the D99 particle size. These small size particles result in a very low wettability, so the filler does not efficiently and naturally mix with the accepting substance, but merely floats on the liquid surface. It is desired to reduce the particle size of the igneous rock filler to as low a value as practical, but the smaller the size the less the wettability. Consequently, there is a great demand (economically) for a filler of the described igneous rock with a maximum particle size D99 of less than 6 microns and indeed less than 4 microns but having a high wettability so the filler will not merely float on top of the receiving substance. The present invention has met this commercial need by creating an igneous rock filler with a maximum particle size D99 of less than 6 microns that has a very high wettability. The new filler does not float (as prior small particle) but immediately, naturally, and rapidly disperses in the accepting liquid, usually paint or a coating. One of the standard commercially accepted tests for wettability is the IDF Method where the wettability is measured as the time in seconds for a powder to be wetted or sink into a container of water. Excellent wettability as obtained by the invention has a test time of less than 60 seconds.

### THE INVENTION

In accordance with the present invention, the igneous rock filler (sometimes referred to as an extender) comprising particles with a maximum particle size D99 of less than 6 microns that have an increased wettability, such as less than 60 seconds as measured by the IDF method of determining wettability. This novel objective is accomplished by applying a liquid or fluid treating agent onto the surfaces of the small dry particles comprising the final powder, i.e. the novel filler. Surface application of the treating agent is performed during the process to produce the small dry particles of the final powder. The term dry as used in this industry means only a small amount of moisture, i.e. less than 1.0 percent moisture. When the process to produce the small dry particles involves wet grinding of larger particles into the small particles with a maximum particle size of less than 5 microns, the wet small particles must be dried where they agglomerate into hard pieces, which are mechanically changed into the original small, ground particles. The surfaces of the small ground particles, which are now dry, are coated by applying the treating agent to the small dry particle in the mechanical changing operation. However, when the process to produce the small particles involves dry grinding of larger particles into the small particles, the small ground particles are coated by applying the treating agent to the particles as they are ground into the desired small size, i.e. less than 6 microns and preferably less than 4 microns. The treating agent is lubricative to increase the wettability of the individual particles as they enter and react with the liquid coating. This concept comprises the basic aspect of the invention and was discovered when using propylene glycol as the treating agent applied to coat the particle surfaces of the dry, small particles forming the new filler.

In accordance with the invention the primary advantage is the high wettability of the individual particles comprising the novel filler. As a secondary feature of the invention, the filler is further enhanced by using a treating liquid or fluid that is also cohesive. Thus, the very fine particles of the filler temporarily form into many clusters of various effective diameters, each containing many diverse sized dry particles which are held together by a very small force. In view of the fact that the treating liquid coated onto the surfaces of the particles is cohesive, the inherently formed clusters immediately disintegrates so the individual high wettability coated particles are dispersed into the liquid constituting the receiving coating. The treating fluid is cohesive and creates “transient agglomerations” via capillary pressure that results in easily dispersed clusters. Consequently, the particles are easily separated during the mechanical action of grinding into the final powder, but cluster together to drastically increase bulk density of the filler as it is being handled and transported. The invention comprises a filler formed from an igneous rock powder with maximum particle size D99 of less than 6 microns and preferably less than 4 microns. This powder has a very high wettability of the individual particles. In accordance with secondary aspect of the invention, the novel high wettability particles form into clusters formed by loosely holding together these novel high wettability particles until the clusters are deposited into the coating. Then, the loosely held particles immediately disperse so the novel high wettability of the particles is realized. This is another property discovered when using propylene glycol to increase wettability.

In accordance with an aspect of the invention, the novel treating agent liquid layer on the particle that covers at least a majority of the total surface area of the particles by using an amount of treating fluid that is at least 1.0 percent and preferably 0.2 to 0.6 percent by weight of the particles in the final powder. The “amount” of treating agent applied as a layer over the surfaces of the finely ground, dry particles is critical and is determined to obtain the desired increased wettability, which is less than 60 seconds as determined by the IDF method of measuring wettability. Indeed, it has been found that less than 20-30 seconds can be obtained by using the invention.

In accordance with the invention, the treating liquid is propylene glycol discovered to have both the primary lubricative property and, also, the cohesive property. Indeed, the invention was discovered when propylene glycol was used to create a thin layer on the surfaces of nepheline syenite particles for use as a filler having a maximum particle size of less than 6 microns.

The primary aspect of the invention is providing a fine grain filler of igneous rock material having increased wettability.

Another primary aspect of the invention is obtaining the increased wettability using propylene glycol.

Yet another primary aspect of the invention is providing such a fine grain filler, as defined above, having the cohesive property realized when propylene glycol is used to coat the surfaces of the particles comprising the powder defining the filler.

In accordance with another primary aspect of the invention, the treating agent coating the surfaces of the particles of the powder defining the filler is less than 1.0 percent by weight of the powder, and preferably 0.2 to 0.6 percent by weight.

In accordance with another aspect of the present invention, the igneous rock is a feldspar rock, i.e. nepheline syenite.

In accordance with a secondary aspect of the invention, the novel filler has a moisture content of less than 1.0 percent.

In accordance with still another aspect of the invention, the actual coating so far successfully using the novel filler with great results are paint, automotive base coat, automotive clear coat, UV curable pud clear wood coating, conventional clear wood floor coating, ink, colorant, and powder coating.

In accordance with an aspect of the invention, there is a novel coting composition created by using the inventive filler and as stated, novel methods are used to create the filler and to use the novel filler for a coating.

In accordance with still another primary aspect of the invention, the novel filler is prepared by a method involving grinding larger nepheline syenite powder into the size of the novel filler and applying the lubricative and cohesive treating liquid onto the surfaces of the dry ground particles. Application of the treating agent liquid is added to ground dry particles after wet grinding or during dry grinding. Since the application must be applied onto dry particles to form the desired coating, when wet processing is used to create the desired small particles, the particles must be ground and then converted back into the originally ground size which receive the treating agent.

The primary object of the present invention is to provide a filler for a coating that is formed from an igneous rock and has a maximum particle size of less than 6 microns, but preferably less than 4 microns, where the individual particles are coated with a treating agent, liquid or fluid. This agent is lubricative so the wetting of the particles is drastically increased. The increase of the wettability is to a value of less than 60 seconds as measured by the IDF method of determining wettability.

A further object of the invention is to provide a novel filler, as defined above, wherein the treating liquid or fluid on the surfaces of the particles is also cohesive so the dry coated particles form different effective clusters of loosely held together particles to, thereby, increase the bulk density of the novel filler. These clusters immediately disintegrate into the individual high wettability, dry particles as the filler is introduced into the coating.

Still a further object of the invention is to provide a novel filler, as defined above, wherein the treating liquid or fluid is propylene glycol.

Yet another aspect of the invention is a method of producing the novel filler by a wet grinding of large particles into the desired small maximum particle size and adding the novel surface treating agent to the ground particles after they are dried into a particle mass and during mechanically changing of the particle mass back into the original ground small particle size. This is unique in producing a filler.

These and other objects, aspects, features and advantages of the invention will become apparent to those skilled in the art upon a reading of the Detailed Description of the invention set forth below taken together with the drawings which will be described in the next section.

### BRIEF DESCRIPTION OF DRAWINGS

The invention may take physical form in certain parts and arrangement of parts, a preferred embodiment of which will be described in detail and illustrated in the accompanying drawings which forms a part hereof and wherein:

FIG. 1 is a drawing of the concept where the novel treating liquid forming to many diverse sized clusters, each having several loosely held together finely ground dry particles where one cluster of which is schematically illustrated;

FIG. 2 is a further schematic illustration of the invention indicating how each cluster of loosely held together dry particles are instantaneously deposited and dispersed into the body of the receiving coating where the high wettability is employed;

FIG. 3 is a block diagram illustrating the method of a first embodiment of the invention and using wet grinding;

FIG. 4 is a block diagram illustrating the method of the production embodiment of the invention and using dry grinding of the large particles into the small, dry particles of the novel filler; and,

FIG. 5 is a graph of the particle distribution of an embodiment of the invention.

### DESCRIPTION OF PREFERRED EMBODIMENTS

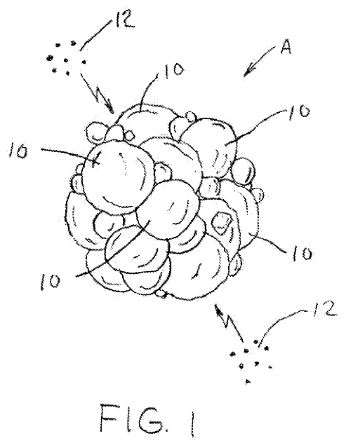

Referring now to the drawings wherein the showings are for the purpose of illustrating preferred and alternative embodiments of the invention only and not for the purpose of limiting the same, the novel filler involves the concept of applying a lubricative and cohesive fluid layer of a surface treating agent onto the surfaces of the very low maximum size filler particles. This treating fluid increases the wettability of the filler. In accordance with a secondary benefit the treating agent is cohesive and causes the particles to naturally clump into a number of easily separated clusters, each containing a large number of very small dry particles. Propylene glycol is the lubricative and cohesive treating fluid used. In the invention, the wettability of the novel filler has been found to be less than 60 seconds using the standard IDF Method of measuring wettability. Indeed, it is less than 30-20 seconds. An inorganic rock filler, such as nepheline syenite with a maximum particle size of 4 microns; but, without surface application of the novel treatment agent, is substantially greater than three minutes (i.e. 180 seconds in this standard test) and the small particle filler merely floats. The moisture content of the novel powder is less than 1.0 percent, preferably 0.2 to 0.6 percent, so the consistency and particle spreadability of the novel filler is excellent. The novel filler is enhanced by the fact that the lubricative and cohesive surface treating fluid applied over the particle surfaces also physically captures the fines (particles less than 0.5 microns) resulting when the mass of particles of the filler are ground to a small size, by either wet grinding or dry grinding. The treating fluid holds the captured fines against the surfaces of the filler particles. In summary, the invention accomplishes the main objective of drastically increasing the wettability. But there are other advantages, such as increasing the Bulk Particle size by forming many particle clusters and also reducing dust created by very small particles. As shown in FIG. 1, dust particles 12 are attracted to treating fluid on dry particles 10. Also, it has been discovered that the novel treating agent increases the shelf-life of the filler, as will be explained later.

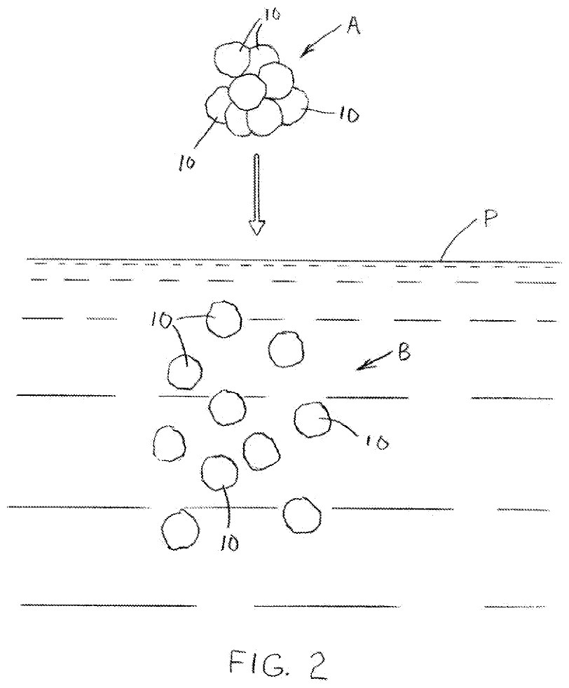

Consequently, the invention broadly involves creating a novel filler employing the concept of treating the surfaces of the dry particles formed from a mass of igneous rock particles having substantially no free silica (defined as less than 0.01 percent by weight of silica). The new filler is a mass of fine particles having a maximum particle size of less than 6 microns, but preferably less than 4 microns. The surface treatment is applying a surface layer of a treating agent comprising a unique fluid applied over the surfaces of the particles when in a dry condition either (a) after the particles are wet ground into the desired small particle size, dried and converted into the dry ground size or (b) when the very small grain filler is produced by dry grinding. The fluid remains as an extremely thin layer on the surfaces and drastically increases the wettability of the individual particles of the final filler. The treating fluid layers on the particle surfaces have a secondary advantage of forming very small grain filler into a vast number of density defining clusters A, as schematically shown in FIG. 1. Each cluster has many different sized particles, which particles are easily releasable because the loose holding action of the cohesive fluid layers. This novel easy release-ability of the particles 10 from the many clusters A when the clusters are deposited into paint P is schematically illustrated in FIG. 2. When clusters A are rapidly deposited in paint P the small cohesive force holding the many particles together cause the cluster to rapidly (immediately) break down, as indicated by the separate particles of group B in the lower part of FIG. 2. This is the clustering and dispersing action caused by the cohesive property of the treating agent or fluid. Since the treating fluid of the layers is cohesive, the particles of clusters A are held together with an extremely low adhesive force. Thus, the novel coating of the small particles is not only a lubricative fluid to increase wettability, but is also a cohesive fluid to only temporarily bind the particles having diverse sizes below the maximum size into multiple clusters A. Each particle 10 is coated with the cohesive treating fluid. It has been determined that this action generally eliminates air voids that would otherwise block capillary action between the particles. This also prevents electrostatic interaction between the small particles. The layer of cohesive fluid or liquid, such as propylene glycol creates a pathway allowing the liquid coating to travel quickly between the particles thereby yielding rapid dispersion. The surface treating agent remains on the dry surfaces of the small particles to thereby accomplish the novel high wettability.

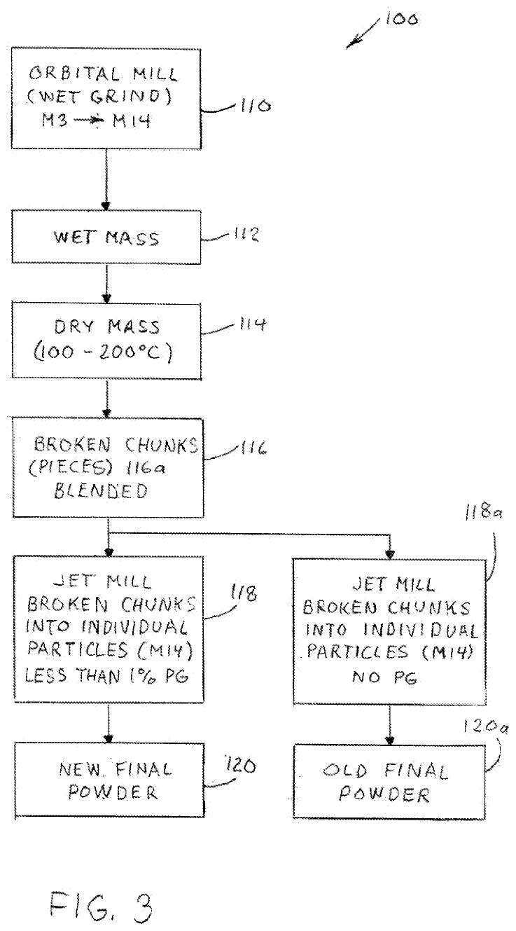

A first preferred embodiment, involves a laboratory production of the novel filler, as disclosed in FIG. 3. A wet grinding method 100 is used to treat the particles with a lubricative surface treating fluid. This treating fluid increases the wettability of the resulting small dry final particles produced by method 100 as the novel filler, labeled “New Final Powder 120”. In practice, operation 110 wet grinds large nepheline syenite particles (Minex 3) by a planetary ball mill to the desired maximum particle size of less than 5 microns. This is the maximum particle size of the commercial Minex 14 (M14). This wet grinding process of operation 110 produces particles defining the final particles 120. The particles are in a slurry or wet mass 112. The wet mass of ground particles designated at block 112 is dried by high temperature operation 114. This drying action forms agglomerated pieces or chunks 116a having the vast numbers of ground final particles rigidly bound together in hard structures or “pieces”. Then the agglomerated pieces or chunks 116a are mechanically shattered by a blender in mechanical changing operation 116 and are separated back into distinct small final particles 120 by a jet mill in operation 118. Various jet mills can be used in operation 118. The new final powder 120 is formed from dry particles produced in operation 110. These dried final particles come out of the jet mill with a moisture content of about 0.5 percent (less than 1.0 percent). They have the desired maximum particle size of less than 4-5 microns as originally created in operation 110.

The final particles produced by operation 110 are converted from a wet version 112 to a dry version in the form of agglomerated hard pieces 116a and then to individual dry particles at milling operation 118. The dry particles produced by mill 118 are original particles created in grinding operation 110 and dried in operation 114. The invention is applying a treating agent onto the surface area of the dried final particles 120. In practice, the invention is performed by using a treating agent that is lubricative and cohesive, such as propylene glycol, as so far explained. Consequently, method 100 converts the large particles M3 into a final powder having dry particles with small particle size M14 as the “new final powder” 120. During the conversion of particles M3 to particles M14 constituting powder or filler 120 the wet ground particles are dried. The novel treating agent is applied to the particles when they are dry and at operation 118. The final particles must be dry and sized back to the ground size of operation 110 by operations 116 and 118. Only then do the particles receive and retain the novel surface coating comprising the invention. In this embodiment, the novel treating agent or fluid is used after final shattering of pieces 116a at the blender of operation 116 and during particle separation (jet mill) of operation 118. It is applied to the dried particles after they are returned back into the particle size from operation 110. They are the final particles 120 of the novel filler.

In method 100, the final powder 120 has dry particles coated with the novel lubricative and cohesive fluid which is added in milling operation 118. The total amount is selected to obtain the desired results and in practice is less than 1.0 percent by weight of the final powder and preferably 0.2 to 0.6 percent.

The invention developed in the laboratory and shown as method 100 in FIG. 3 is nepheline syenite powder (special igneous rock) with a maximum particle size of about 50-100 microns that is wet processed by an orbital ball mill in operation 110. The ground particles are in a slurry where the nepheline syenite powder has a maximum particle size of less than 4-5 microns. This fine grain slurry is wet mass 112. This mass is then dried in operation 114 at a high temperature for a time to produce a dry broken chunk hard agglomerations or “pieces” 116a. Then the dried fine grains slurry or dry pieces 116a are processed in an aggressively operated mechanical blender in operation 116 The dry pieces 116a are further processed by a jet mill in operation 118 where the dried, sized particles are surface coated to produce the final fine grain, dry powder 120. Preferably 0.2-0.6 percent by weight propylene glycol is introduced at operation 118. In practice, less than 1.0 percent by weight of propylene glycol has been used to practice the invention. The final dry particles are no longer agglomerated as in operation 114. The surface of each separate particle of the dry powder 120 is coated with thin layer of a treating fluid or agent, in the preferred embodiment it is propylene glycol.

In summary, irrespective of the process operations to produce powder 120, though the processes are also novel and inventive, the novel final powder is a fine grain nepheline syenite dry powder with particle surfaces coated by a small amount of a lubricative surface treating fluid, i.e. propylene glycol. Such fine grain nepheline syenite powder is used as a mineral “filler” for a coating material, such as paint, etc. This novel mineral filler or powder 120, with particle surfaces coated with propylene glycol, increases hardness, scratch resistance, clarify and color of the coating. Most importantly, the propylene glycol coating allows the nepheline syenite filler to wet easily and quickly mix into the coating, such as paint P by the particle dispersion procedure illustrated in FIG. 2. The final powder has excellent wettability. Furthermore, the surface coating layer makes the powder essentially dust free. The added, thin surface coating layer on the particles is also cohesive to cause cluster A and capture fines 12 as shown in FIG. 1. The clusters immediately disintegrate and disperse particles 10 as shown in FIG. 2. Thus, the new mineral filler of the invention imparts desired physical properties to the receptive coating while allowing efficient mixing of the mineral filler into the coating material. The final nepheline syenite filler powder of the invention employs the smallest particle size now commercially produced, i.e. a powder with a maximum particle size D99 of less than 4-5 microns and is commercially defined under the trademark Minex as size M14 and the wettability is increased to less than 60 seconds and preferably less than 30-20 seconds using the IDF wettability measurement.

Thus, a novel treating agent covers the surfaces of the very fine dry mineral powder with a thin layer, thereby creating the novel mineral filler or powder 120. The treating agent creates the properties of high wettability and the cluster forming and dispersing concept shown in FIGS. 1 and 2.

In an early implementation of the first embodiment, operation 110 involved 200 grams of Minex 3 with D99 of about 100 microns that was wet ground and a small amount of propylene glycol (preferably 0.25-1.0 percent by weight of the Minex 3, as a grinding aid, not as used in the invention). The mechanical grinding in operation 110 used any standard wet grinding mechanism. A wet mass (slurry) of nepheline syenite powder was produced after about 2-3 hours. The wet mass was dried overnight at 100-200° C. to an agglomerated dried mass as dry broken pieces or “chunks” 116a having the small dry particles. These pieces are then placed into an aggressive blending or grinding operation 116 and then into a jet mill of operation 118. The final processing mechanism of operations 116 and 118 may be a blender, a mechanical mill, etc., to convert aggressively the dry broken pieces 116a into the final, evenly dispersed, dry powder 120. This powder constitutes the novel invention of dry particles coated with propylene glycol, the lubricative and cohesive surface treating agent at operation 118.

The disclosed, developed inventive concept is treating the surfaces of the individual dry particles in the total mass of igneous rock particles to create a surface layer of treating agent or fluid on the final particles. The layer of the treating agent or fluid remains on each particle constituting the particles of the novel filler and covers a majority of the surfaces, i.e. at least 50 percent and preferably over 60 percent. In summary, a novel filler has been created where layers of cohesive, lubricative fluid causing the high wettability dry particles of the mass to automatically clump into a vast number of small clusters A and quickly disperse, as schematically illustrated in FIG. 2. Each cluster A is formed by a great number of different sized particles schematically illustrated as particles 10 constituting distinct particles very loosely held together by the cohesive property of the treating fluid comprising layers of surface treatment agent. Formation of a large number of different sized clusters A, each comprising many particles, decreases the effective surface area of the mass, thus, increases the “Effective Partial Size” or bulk density of the filler or mass. Clusters A are formed by a vast number of particles having sizes below the maximum particle size of the dry final particles. Consequently, the filler is made more dense and is better able to be handled and applied to a liquid body, such as paint P. Since clusters A have less surface area, they plunge into the liquid rapidly. Particles 10 are subsequently and rapidly (naturally) dispersed into the liquid body as group B, due to the increased wettability imparted to each particle by the lubricative fluid. Thus, dispersion is facilitated. The releasing action of the particles forming clusters A is extremely rapid because of the very low cohesive force holding them together. A surprising and novel feature of the development is that the particles are loosely held together by the surface layer of cohesive fluid, naturally forming into many, multiple particle clusters A. Such particle clusters are created by use of the novel wettability controlling treating agent or fluid. In practice, the treating fluid is propylene glycol. The treating fluid to create the physical properties of the novel filler also increases bulk density to improve distribution; but not cause non-dispersible “caking” as occurs when too much of the novel treating fluid is used. Each cluster A has undefined number of many particles and gather or capture loose fines 12 (dust) created when grinding the mass. In summary, novel surface treatment of the particles causes the clusters to be formed naturally. More importantly, the novel surface treatment causes the particles to easily separate as the clusters rapidly enter and disperse as separate particles in paint P. The particles 10 of these clusters are loosely held together and are not fixedly held together, such as in hard agglomerations of the dried clunks or pieces 116a in operation 116. The clusters quickly disintegrate into separate particles shown as a group of separated particles labeled B in FIG. 2 and the separate particles are rapidly mixed into the body of paint P.

The novel filler or new final powder 120 is a mass of igneous rock particles with substantially no free silica. It has particles with a defined small maximum particle size of less than 5 microns and with surfaces having a layer of treating agent or fluid imparting novel properties to the particle mass, as explained. This new filler performs the characteristics of a hard, small grain filler and the particles have a high wettability to allow the rapid acceptance and dispersion of particles 10. As a secondary advantage, this agent or fluid controls the density of the filler by forming into a number of multiple effective diameter clusters A, each with loosely held together, individually dispersible, particles that separate automatically, and immediately, once the clusters are fed or dropped into a liquid substance, as shown in FIG. 2. The wettability of the particle mass or new filler 120 is substantially greater than a filler with untreated particle surfaces. Indeed, the wettability is less than 60 seconds and preferably less than 30-20 seconds in any IDF Method test. The particles of the igneous rock being used for a filler has free OH groups on the surface, so the agent or fluid creates the surface layers by hydrogen bonding and the fluid also captures and, thus, eliminates fines (dust) 12, as shown in FIG. 1. The surface treating agent creates a layer of lubricative fluid over a majority of the surfaces of the particles so when the powder is dumped into a large vat of liquid, such as paint P, in the general form of the aforementioned clusters A, particles 10 are separated and wetted out. The IDF Method reveals an acceptable measured time of much less than 60 seconds, but a desired measured time of less than 30-20 seconds is obtained by the invention. The cohesive forces caused by the propylene glycol on the particle surfaces that creates clusters A also draws water into the clusters to break them down into individual, particles 10, as represented as particle group B.

The coatings using the new filler may be various types, i.e. paint, wood coating or other surface coatings. Although the invention has been described as a mineral “filler”, the novel dry final powder 120 modified to include surface treatment to provide a treating agent, such as propylene glycol over the surfaces of the fine powder may have other uses. The advantages obtained by the discovery of using a lubricative liquid or fluid to coat the particles of ultra-fine mineral powder (nepheline syenite at D99 of less than 5 microns), may be obtained by using a treating fluid so long as it has the wettability values obtained by lubricative property of propylene glycol. It is also advantageous for the treating fluid to have the cohesive property of propylene glycol so the features described in FIGS. 1 and 2 are obtained. A chemical having technically the same lubricative and cohesive properties of propylene glycol would be an “equivalent to propylene glycol”. Propylene glycol is known by many chemical names, such as 1,2-Propanediol, 1,2-Dihydroxypropane, Methyl ethyl glycol, Methyl ethylene glycol and Glycol.

As mentioned earlier in this disclosure, it was found that use of propylene glycol in the amount of 0.2 to 0.6 in operation 118 of FIG. 3 drastically increases the shelf-life of new final powder 120. In the past, production of a nepheline syenite powder into maximum particle size of less than 4-5 microns often use a wet process similar to method 100 in FIG. 3. Operation 118 was performed without use of the lubricative fluid treating agent and, for illustration, is shown as operation 118a. This procedure produced what is referred to as “old” powder 120a. For reasons explained, powder 120a had commercially unacceptable low wettability. This previously produced M14 powder is full of crusty macroscale hard non-dispersible agglomerates with a shelf-life of less than 6 months, whereas the new final powder 120 of the invention has remained generally in its novel condition for well over six months. Indeed, it remains in such novel condition without any indication of reverting to the unacceptable condition of prior powder 120a. This drastic and apparently continuing shelf-life increase is the effect of using the treating liquid for controlling the salt bridging of the particles. Furthermore, highly reactive moieties, salts, and electrostatic interactions between the small particles of prior powder 120a draws the particle close together allowing for formation/reformation of a large number of chemical/ionic bonds which renders powder 120a generally unusable in a short time. This short shelf-life feature is in addition to the low wettability of prior powder 120a. Use of propylene glycol appears to pacify the highly reactive moieties and, thus, prevents electrostatic forces or salt bridging from bonding particles of new final powder 120 close together. The propylene glycol effectively reduces salt bridging of the particles. For this additional reason of increased shelf-life, new powder 120 is a drastic improvement over old or prior powder 120a.

### Production Run

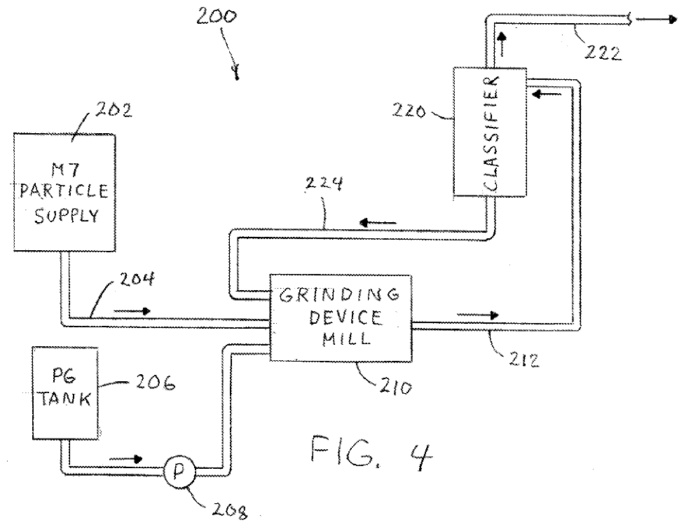

The actual production run of the invention is illustrated in FIG. 4 where the invention uses dry grinding so there is no need to dry the particles into “final” particles before or while applying the novel treating agent. Supply 202 of nepheline syenite powder having a maximum particle size D99 of about 20 microns is directed as indicated by line 204 to dry grinding device 210, which is preferably a conical grinding mill; however, various dry grinding devises can be employed. Simultaneously, propylene glycol PG is directed from tank 206 by way of dosage pump 208. In practice, the PG dosage is 0.5 percent by weight of powder from supply 202. This method is dry grinding so the propylene glycol merely functions to produce the dry, final particles of the novel filler as so far disclosed herein. The dry final particles are coated as they are being ground into the desired maximum particle size D99 of less than 6 microns and preferably less than 4 microns.

The stated particle size of the input powder in supply 202 and the PG dosage of pump 208 are used in production method 200. However, the “particle size” of the powder in supply 202 can be any larger sized nepheline syenite available at the manufacturing plant, such as M-3 with a D99 particle size of about 50 microns and M-7 with a D99 particle size of about 20 microns. As a general inventive definition, the size could be stated as “less than 100 microns” or “less than 50 microns”. The dosage of propylene glycol PG from tank 206 is less than 1.0 percent by weight of the input mass from supply 202 so the final dry powder has a preferred coating of 0.2 to 0.6 percent by weight. Dry grinding with PG is theoretically different from using wet grinding in method 100 where propylene glycol could also (but irrelevantly) be used as an aid to the wet grinding. The invention is not novel grinding. The invention is a very fine filler with dry powders having novel surface conditions caused by surface coating with a thin layer. The layer is applied onto the surfaces of dry particles as method 200 converts the large particles of supply 202 into the “final” particles in output line 222.

Mill 210 dry grinds the nepheline syenite powder into a fine, ground powder that is carried by the air flow from mill 210 through line 212 to a somewhat standard particle classifier 220 to separate the dry propylene glycol coated particles (less than 0.5 percent moisture content) having the final “targeted size” for discharge through line 222. This discharge is the novel filler with particle size of less than 6 microns or preferably less than 4 microns. Indeed, less than 5 microns. Thus, the separated particles discharged through output line 222 are the filler or final powder of the invention. In practice, the particles from line 222 are the size of Minex 14, i.e. with maximum size of less than 4 microns. In accordance with SOP, coarse fraction particles return to mill 210 from classifier 220 by way of output line 224. Method 200 is a second embodiment and does not need drying to convert the final particles to a dry condition so they can be treated in accordance with the invention. It is, thus, different from the wet grinding method 100.

The described method 200 run had a set PG dosage of 0.5 percent by weight and the final coated particles (filler) are transported to the output receptacle by line 222. The final powder had the desired maximum particle size as already described. Furthermore, the final powder had an IDF Method test of less than 60 seconds and, indeed, less than 20-30 seconds. This desired high wettability property was obtained when up to 1.0 percent by weight PG was employed in method 200. It was discovered that less than 1.0 percent by weight was the “limited” amount necessary for a commercially usable product. As the amount approached 1.0 percent, the treated powder started “caking” and the “not” floating property was compromised. Indeed, it was discovered that 0.2 to 0.6 percent by weight was preferred to obtain both high wettability and a commercially usable product.

In one implementation of method 200, device 210 is a conical grinding mill having a cylindrical section with dimensions of 8 feet by 48 inches (external), running at about 21 rpm with a critical speed of 72 percent. It has 5 inch liners. Mill 210 has a grate at the discharge end with original slots of % inches. It has a 45-50% by volume of an alumina pebble media. The fresh (original) charge of media is (a) 3,000 pounds of 1¼ inch pebbles; (b) 2,500 pounds of 1 inch pebbles; and (c) 1,000 pounds of % inch pebbles. Rotation of the mill creates a tumbling action of the media. The media hits the particles of the input mass from supply 202 and also coats the particle with a surface layer of propylene glycol from tank 206. This action coats and breaks the particle into finer sizes. Indeed, the propylene glycol is used to create the novel particle surface treatment. Propylene glycol is used in the disclosed production development method 200 to obtain the invention. Air flow through the mill carries the most fine particles with surface layers of PG while the coarser particles stay in the mill until they ultimately reach a size that could be carried from the mill by air flow out line 212.

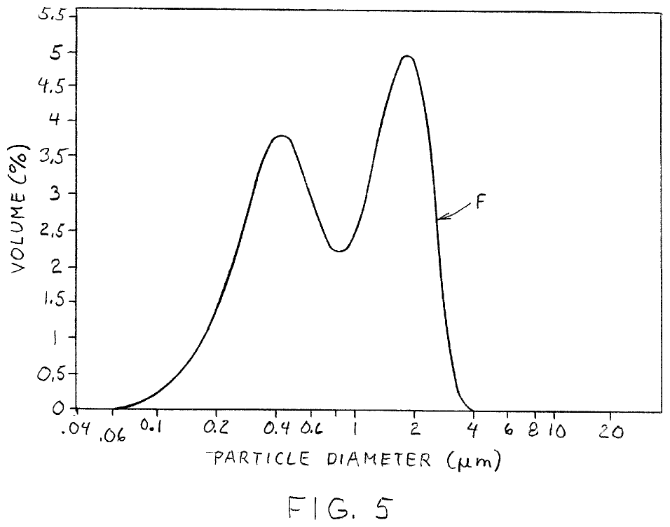

As a background test using dry grinding, Minex-3 nepheline syenite powder (D99 over 50 microns) was ground dry in a grinder 210 comprising an orbital ball mill for 2.5 hours at 350 rpm using 3 mm (Yttria) resulting in a fine powder with a D99 of less than 4 microns. This is “less than 6 microns”, the broadest particle size limitation of the invention and less than 5 microns, as preferred. Without adding lubricative fluid surface treating agent, the powder had an IDF Method wettability time of well over three minutes. The powder merely floated on the test water surface. This was unacceptable. When the procedure was repeated with 0.6 percent propylene glycol by weight of Minex-3 powder used during dry grinding, the wettability of the powder was drastically increased to an IDF Method wettability time of less than 30 seconds (drastically less than the acceptable 60 seconds) and the moisture content was about 0.5 percent so the particles were easily handled. Surprisingly, the mass naturally formed into many clusters A, as shown in FIGS. 1 and 2. It was found these clusters rapidly mixed into paint P in the manner, as illustrated in FIG. 2. A graph F of the particle distribution obtained by method 200 in FIG. 4 is disclosed in FIG. 5. The particles are less than 4 microns which is a preferred embodiment of the invention and, also, less than 5 microns.

### Amount of Treating Fluid

The treating fluid must cover a majority of the surfaces of the particles with a thin layer. This is done when the particles are dry and converted to the size of the “final” particles as by method 100 or method 200. This action of coating dry particles is different from a wet grinding where propylene glycol has been used as a grinding aid. Grinding aids have no purpose after grinding. They do not coat the particles. Indeed, when particles are wet ground, a grinding aid is in solution. It evaporates with the water as the “final” particles are heated as in operation 114. In the invention, a majority of the particle surface area must be covered by the fluid to obtain the invention disclosed herein. This requires a surface treatment agent which is less than 1.0 percent by weight of the “final” dry particles. Preferably, the weight of the surface treatment agent is 0.2 to 0.6 percent by weight of the particles. Consequently, the very large surface area caused by the creation of a vast number of very small particles is covered by a thin layer of the treating agent. The purpose of the treating fluid coating the particles relates to its use of the dry particles after grinding. The objective is to apply a coating on the surfaces of the fine particles forming the final dry powder. The actual amount of fluid is in the inventive range of less than 1.0 percent by weight and preferably 0.2 to 0.6 percent by weight. It has been discovered that if this amount is exceeded, the filler is inoperative and cannot be used as a filler because of the unacceptable “caking”. Indeed, the critical amount of treatment liquid and its limitation is a discovery constituting another important aspect of the invention.

### Statements of Invention

A. A filler for a coating comprising a powder formed from igneous rock with substantially no free silica and a Mohs hardness of at least 5 and a controlled maximum particle size of less than 6 microns, wherein said particles have a surface fluid layer of a lubricative fluid to drastically increase the wettability of said powder.
B. The filler as defined in claim A wherein said increased wettability is less than 60 seconds as measured by the IDF method of determining wettability.
C. The filler as defined in claim B wherein said particles have at least a majority of the particle surface area covered by said fluid layer.
D. The filler as defined in claim A wherein said particles have at least a majority of the particle surface area covered by said fluid layer.
E. The filler as defined in claim B wherein said surface fluid layer is also a cohesive fluid so the density of said powder is defined by said particles being clumped into clusters having many particles with diverse particle sizes loosely held together until said powder is deposited into said coating.
F. The filler as defined in claim A wherein said surface fluid layer is also a cohesive fluid so the bulk density of said powder is defined by said particles being clumped into clusters having many particles with diverse particle sizes loosely held together until said powder is deposited into said coating.
G. The filler as defined in claim F wherein said lubricative and cohesive fluid is a treating fluid having lubricative and cohesive properties technically equivalent to propylene glycol.
H. The filler as defined in claim F wherein said lubricative and cohesive fluid is propylene glycol.
I. The filler as defined in claim F wherein said igneous rock is nepheline syenite.
J. The filler as defined in claim E wherein said igneous rock is nepheline syenite.
K. The filler as defined in claim F wherein the moisture content of said filler is less than 1.0 percent.
L. The filler as defined in claim E wherein the moisture content of said filler is less than 1.0 percent.
M. The filler as defined in claim E wherein said surface fluid layer comprises less than 1.0 percent of the weight of the particles in said filler.
N. The filler as defined in claim M wherein said surface fluid layer comprises 0.2 to 0.6 percent of the weight of the articles in said filler.
O. A filler as defined in claim E wherein said coating is selected from the class consisting of: paint, automotive base coat, automotive clear coat, UV curable pud clear wood coating, conventional clear wood floor coating, ink, colorant, and powder coating.
P. A method of producing a filler for a coating, said method comprising:

(a) converting a particle mass of igneous rock having a maximum particle size D99 at a given level into a dry final particles having a reduced maximum particle size of less than 6 microns; and,

(b) during said converting operation applying a surface layer of a treating fluid onto said dry final particles which fluid is lubricative so said dry final particles have a drastically increased wettability, said treating fluid being applied in an amount to obtain the desired increase in wettability of said dry final particles which comprises said filler.
Q. The method as defined in claim P wherein said converting operation is a wet grinding operation to create a slurry having a wet mass of said final particles and including:

(c) drying said wet mass of said final particles into dried agglomerated pieces of said final particles;

(d) mechanically changing said dried agglomerated pieces into individual dry final particles; and,

(e) applying said surface layer to said dry final particles during said mechanically changing operation.
R. The method as defined in claim P wherein said converting operation is merely a dry grinding operation to form said dry final particles and including:

(c) applying said surface layer to said dry final particles during said grinding operation.
S. The method as defined in claim P wherein said amount of treating fluid is 0.2 to 0.6 percent by weight of said dry final particles.
T. The method as defined in claim P wherein said treating fluid is also cohesive so said dry final particles have a tendency to loosely adhere to each other thereby forming multi-particle clusters, which clusters rapidly disintegrate into individual final particles when said clusters are introduced into said coating.
U. The method as defined in claim T wherein said lubricative and cohesive fluid is a treating fluid having lubricative and cohesive properties technically equivalent to propylene glycol.
V. The method as defined in claim T wherein said lubricative and cohesive fluid is propylene glycol.
W. The method as defined in claim P wherein said igneous rock is nepheline syenite.
X. A coating composition comprising a filler defined in any one of claims A to O.
Y. A coating composition as defined in claim X wherein the composition is selected from the class consisting of: paint, automotive base coat, automotive clear coat, UV curable pud clear wood coating, conventional clear wood floor coating, ink, colorant and powder coating.
Z. A filler obtained by using the methods defined in any one of claims P-W.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation. In addition, the claims form part of the disclosure.

It is claimed:

1. A filler for a coating comprising a powder formed from igneous rock with substantially no free silica and a Mohs hardness of at least 5 and a controlled maximum particle size of less than 6 microns, wherein said particles have a surface fluid layer of a lubricative fluid to drastically increase the wettability of said powder.

2. The filler as defined in claim 1 wherein said increased wettability is less than 60 seconds as measured by the IDF method of determining wettability.

3. The filler as defined in claim 2 wherein said particles have at least a majority of the particle surface area covered by said fluid layer.

4. The filler as defined in claim 1 wherein said particles have at least a majority of the particle surface area covered by said fluid layer.

5. The filler as defined in claim 2 wherein said surface fluid layer is also a cohesive fluid so the density of said powder is defined by said particles being clumped into clusters having many particles with diverse particle sizes loosely held together until said powder is deposited into said coating.

6. The filler as defined in claim 1 wherein said surface fluid layer is also a cohesive fluid so the bulk density of said powder is defined by said particles being clumped into clusters having many particles with diverse particle sizes loosely held together until said powder is deposited into said coating.

7. The filler as defined in claim 6 wherein said lubricative and cohesive fluid is a treating fluid having lubricative and cohesive properties technically equivalent to propylene glycol.

8. The filler as defined in claim 6 wherein said lubricative and cohesive fluid is propylene glycol.

9. The filler as defined in claim 6 wherein said igneous rock is nepheline syenite.

10. The filler as defined in claim 5 wherein said igneous rock is nepheline syenite.

11. The filler as defined in claim 6 wherein the moisture content of said filler is less than 1.0 percent.

12. The filler as defined in claim 5 wherein the moisture content of said filler is less than 1.0 percent.

13. The filler as defined in claim 5 wherein said surface fluid layer comprises less than 1.0 percent of the weight of the particles in said filler.

14. The filler as defined in claim 13 wherein said surface fluid layer comprises 0.2 to 0.6 percent of the weight of the articles in said filler.

15. A filler as defined in claim 5 wherein said coating is selected from the class consisting of: paint, automotive base coat, automotive clear coat, UV curable pud clear wood coating, conventional clear wood floor coating, ink, colorant, and powder coating.

16. A method of producing a filler for a coating, said method comprising:
(a) converting a particle mass of igneous rock having a maximum particle size D99 at a given level into a dry final particles having a reduced maximum particle size of less than 6 microns; and,
(b) during said converting operation applying a surface layer of a treating fluid onto said dry final particles which fluid is lubricative so said dry final particles have a drastically increased wettability, said treating fluid being applied in an amount to obtain the desired increase in wettability of said dry final particles which comprises said filler.

17. The method as defined in claim 16 wherein said converting operation is a wet grinding operation to create a slurry having a wet mass of said final particles and including:
(c) drying said wet mass of said final particles into dried agglomerated pieces of said final particles;
(d) mechanically changing said dried agglomerated pieces into individual dry final particles; and,
(e) applying said surface layer to said dry final particles during said mechanically changing operation.

18. The method as defined in claim 16 wherein said converting operation is merely a dry grinding operation to form said dry final particles and including:
(c) applying said surface layer to said dry final particles during said grinding operation.

19. The method as defined in claim 16 wherein said amount of treating fluid is 0.2 to 0.6 percent by weight of said dry final particles.

20. The method as defined in claim 16 wherein said treating fluid is also cohesive so said dry final particles have a tendency to loosely adhere to each other thereby forming multi-particle clusters, which clusters rapidly disintegrate into individual final particles when said clusters are introduced into said coating.

21. The method as defined in claim 20 wherein said lubricative and cohesive fluid is a treating fluid having lubricative and cohesive properties technically equivalent to propylene glycol.

22. The method as defined in claim 20 wherein said lubricative and cohesive fluid is propylene glycol.

23. The method as defined in claim 16 wherein said igneous rock is nepheline syenite.

24. A coating composition comprising a filler defined in claim 1.

25. A coating composition as defined in claim 24 wherein the composition is selected from the class consisting of: paint, automotive base coat, automotive clear coat, UV curable pud clear wood coating, conventional clear wood floor coating, ink, colorant and powder coating.

26. A filler obtained by using the method defined in claim 16.
